(19) United States
(12) Patent Application Publication
(10) Pub. No.: US 2026/0216892 A1
(43) Pub. Date: Jul. 30, 2026

(54) ROTARY POWER UNIT, TWO-STAGE SPEED REDUCTION ROTARY POWER UNIT, AND ROBOT

(71) Applicant: HangZhou YuShu TECHNOLOGY CO.,LTD., Hangzhou (CN)

(72) Inventors: Xingxing WANG, Hangzhou (CN); Zhiyu YANG, Hangzhou (CN)

(21) Appl. No.: 19/127,668

(22) PCT Filed: Jun. 29, 2023
(86) PCT No.: PCT/CN2023/103698

§ 371 Date: May 6, 2025

(30) Foreign Application Priority Data
Nov. 11, 2022 (CN) 202211412204.7

(51) Int. Cl. B25J 13/08; B25J 9/10; F16H 1/32; F16H 1/46; F16H 57/02

(52) U.S. Cl. CPC B25J 13/088; B25J 9/102; F16H 1/32; F16H 1/46; F16H 2057/02034

(57) ABSTRACT

A two-stage speed reduction rotary power unit includes a base, and a motor unit and a speed reducer unit provided in the base. The motor unit includes a motor rotor. The speed reducer unit includes a first-stage planetary speed reduction mechanism and a second-stage planetary speed reduction mechanism. The second-stage planetary speed reduction mechanism includes a second-stage sun gear, a second-stage planetary gear, a second-stage planetary carrier, and a second-stage internal gear ring; and a hollow output angular rotation transfer member is coaxially and fixedly connected to the second-stage planetary carrier, and the output angular rotation transfer member extends toward the motor rotor.

### TECHNICAL FIELD

The present invention relates to the technical field of robot devices, and in particular, to a rotary power unit, a two-stage speed reduction rotary power unit, and a robot.

### BACKGROUND

A rotary power unit is a core component of a robot, and the performance thereof directly affects dynamic performance of the robot. However, most existing rotary power units use a one-stage planetary speed reduction system with relatively a small speed reduction.

The Chinese patent (publication No. CN 114789761 A) discloses an electrically driven joint and a three-degree-of-freedom joint integration module for a bionic robot. The electrically driven joint includes a housing assembly, a motor assembly, a first-stage speed reducer assembly, a second-stage speed reducer assembly, an encoder assembly, and a bearing set. The module includes a knee joint unit, a forward swing unit, a side spreading unit, and a leg unit. The electrically driven joint uses an axial magnetic flux motor. The knee joint unit is arranged in the same direction as a forward swing joint unit, and an output axis of a side spreading joint unit is arranged orthogonally with an axis of a forward swing joint. The encoder assembly includes an encoder and an encoder magnet pole. A tail end of an output shaft is fixedly connected to a magnetic encoder magnet. An encoder acquisition board 5.1 is fixed on the housing assembly.

However, the encoder assembly in the above solution can only detect and feed back a state of an output end, and cannot detect or feed back a state of an input end (rotor end) of the motor, affecting the control precision of an electrically driven rotary unit. If another encoder assembly is directly provided at the input end of the motor, it is required to arrange cables at both the output end and the input end of the motor and design two routes, making cabling of the electrically driven rotary unit complex, resulting in low reliability.

Further, the above dual-speed reducer solution discloses no routing manner for cables. If the cables are disposed externally, the cable life may be affected, and the cabling of the rotary unit is complex; and if conventional hollow routing is used, the cables need to directly pass through various components, resulting in a safety hazard.

The information disclosed in the Background is used only for understanding the background of the conception of the present invention, and thus may include information that does not constitute the prior art.

### SUMMARY

In view of the above problems or one of the above problems, the first objective of the present invention is to provide a rotary power unit, which is provided with an output angular rotation transfer member to gather up state monitoring for an input end and state monitoring for an output end, so that an output rotation sensor, together with an input rotation sensor, can be provided at a front end portion or rear end portion of the rotary power unit, in which case the states of the input end and the output end of the rotary power unit can be monitored and fed back by arranging cables at only one end of the rotary power unit, making cabling of an electrically controlled system of the rotary power unit simple, resulting in high reliability and low costs.

In view of the above problems or one of the above problems, the second objective of the present invention is to provide a two-stage speed reduction rotary power unit, which is provided with an output angular rotation transfer member to gather up state monitoring for a second-stage planetary carrier and state monitoring for a motor rotor, in which case the states of the input and the output of the two-stage speed reduction rotary power unit can be monitored and fed back by arranging cables at the motor rotor, making cabling of an electrically controlled system of the rotary power unit simple, resulting in high reliability and low costs.

In view of the above problems or one of the above problems, the third objective of the present invention is to provide a two-stage speed reduction rotary power unit, which has a compact structure and uses two-stage planetary speed reduction to increase a speed reduction ratio.

In view of the above problems or one of the above problems, the fourth objective of the present invention is to provide a robot, which is provided with an output angular rotation transfer member to make cabling of an electrically controlled system simple, resulting in high reliability, and uses two-stage planetary speed reduction to increase a speed reduction ratio.

In order to achieve one of the above objectives, the first technical solution of the present invention is as follows:
a rotary power unit,
including an input end and an output end, where
one of the input end and the output end is provided with an input rotation sensor, and the other is fixedly connected to an output angular rotation transfer member;
the output angular rotation transfer member extends toward the input rotation sensor;
an output rotation sensor is provided at a position adjacent to the input rotation sensor; and
the output rotation sensor is connected to the output angular rotation transfer member, so as to detect states of the input end and the output end at an end of the rotary power unit.

In the present invention, after continuous exploration and experimentation, the output angular rotation transfer member is provided to gather up state monitoring for the input end and state monitoring for the output end, so that the output rotation sensor, together with the input rotation sensor, can be provided at a front end portion or rear end portion of the rotary power unit, in which case the states of the input end and the output end of the rotary power unit can be monitored and fed back by arranging cables at only one end of the rotary power unit, making cabling of an electrically controlled system of the rotary power unit simple, resulting in high reliability and low costs.

The input rotation sensor and output rotation sensor are photoelectric sensors, Hall rotation speed sensors, encoders, or laser rotation speed sensors, respectively.

The state monitoring includes posture monitoring or/and angle monitoring or/and rotation speed monitoring.

As a preferred technical measure:
the input end and the output end are each provided with a hollow rotary center.

The output angular rotation transfer member is a T-shaped structure provided with a through hole, and a rod portion thereof passes through the hollow rotary center. Accordingly, the cable can pass through the through hole of the output angle rotation transfer member, avoiding external arrangement of the cable; and the cable is isolated from the outside by the output angle rotation transfer member, avoiding contact of the cable with various components and wear thereof, resulting in high safety and making the solution practicable.

Further, the input end is a rotor of a motor unit or an input end of a speed reducer unit, and may be of a cylindrical structure, a sheet structure, a frame structure, a square structure, or an annular structure.

Further, the output end is an output end of a first-stage planetary speed reduction mechanism or a second-stage planetary speed reduction mechanism, and may be of a cylindrical structure, a sheet structure, a frame structure, a square structure, or an annular structure.

In order to achieve one of the above objectives, the second technical solution of the present invention is as follows:
a rotary power unit, including a motor unit and a speed reducer unit, where the motor unit is provided with a rotation portion;
the speed reducer unit is provided with an input end and an output end;
the input end is fixedly connected to the rotation portion, and one of the input end and the output end is provided with an input rotation sensor;
the output end is fixedly connected to an output angular rotation transfer member;
the output angular rotation transfer member extends from the output end toward the input rotation sensor;
an output rotation sensor is provided at a position adjacent to the input rotation sensor; and
the output rotation sensor is connected to the output angular rotation transfer member, so as to detect states of the input end and the output end at the input end.

When the input rotation sensor is provided at the rotation portion of the motor unit, the input rotation sensor is a motor rotor rotation sensor; and when the input rotation sensor is provided at the input end of the speed reducer unit, the input rotation sensor is an input angular rotation sensor.

In the present invention, after continuous exploration and experimentation, the output angular rotation transfer member is provided at the output end to gather up, at the input end or the motor rotor, state monitoring for the output end and state monitoring for the input end or the motor rotor, so that the output rotation sensor, together with the input rotation sensor, can be provided at a rear end portion (input end) of the rotary power unit, in which case the states of the input end and the output end of the rotary power unit can be monitored and fed back by arranging cables at only the rear end of the rotary power unit, making cabling of an electrically controlled system of the rotary power unit simple, resulting in high reliability and low costs. In order to achieve one of the above objectives, the third technical solution of the present application is as follows:
a two-stage speed reduction rotary power unit, including a base, and a motor unit and a speed reducer unit provided in the base, where
the motor unit includes a motor rotor, and the speed reducer unit includes a first-stage planetary speed reduction mechanism and a second-stage planetary speed reduction mechanism;
the first-stage planetary speed reduction mechanism includes a first-stage sun gear, a first-stage planetary gear, a first-stage planetary carrier, and a first-stage internal gear ring, where the first-stage sun gear is coaxially and fixedly connected to the motor rotor, the first-stage internal gear ring is fixed within the base, the first-stage planetary gear is engaged between the first-stage sun gear and the first-stage internal gear ring, and power is output through the first-stage planetary carrier;
the second-stage planetary speed reduction mechanism includes a second-stage sun gear, a second-stage planetary gear, a second-stage planetary carrier, and a second-stage internal gear ring, where the second-stage sun gear is coaxially and fixedly connected to the first-stage planetary carrier, the second-stage internal gear ring is fixed within the base, the second-stage planetary gear is engaged between the second-stage sun gear and the second-stage internal gear ring, and power is output through the second-stage planetary carrier; and
a hollow output angular rotation transfer member is coaxially and fixedly connected to the second-stage planetary carrier, and the output angular rotation transfer member extends toward the motor rotor.

In the present invention, after continuous exploration and experimentation, the output angular rotation transfer member is provided to gather up state monitoring for the second-stage planetary carrier and state monitoring for the motor rotor, in which case the states of the input and the output of the two-stage speed reduction rotary power unit can be monitored and fed back by arranging cables at the motor rotor, making cabling of an electrically controlled system of the rotary power unit simple, resulting in high reliability and low costs.

In addition, the speed reducer unit of the two-stage speed reduction rotary power unit provided by the present invention uses two-stage planetary speed reduction to provide a high speed reduction ratio; and an output speed reduction ratio may be flexibly adjusted according to different use conditions, for example, the use at a hip joint or a knee joint of a robot.

As a preferred technical measure:
the motor rotor is recessed inward at a rotary center to form an accommodation cavity for accommodating the first-stage planetary speed reduction mechanism, making a joint unit have a compact structure and a small axial dimension. Further, the rotor is provided with an accommodation cavity therein for accommodating the first-stage planetary speed reduction mechanism, so as to make full use of the space, thus making the rotary power unit have a more compact overall structure and a smaller volume.

And/or the output angular rotation transfer member passes through the second-stage planetary carrier, the second-stage sun gear, the first-stage planetary carrier, the first-stage sun gear, and the motor rotor, making the rotary power unit have a compact structure.

As a preferred technical measure: a support seat is directly fixed within the base, and the first-stage internal gear ring and the second-stage internal gear ring are each fixed within the base through the support seat; and
a buffer protrusion and a buffer recess matching each other are provided between the first-stage internal gear ring and the support seat and between the second-stage internal gear ring and the support seat, respectively.

As a preferred technical measure:
a motor rotor rotation sensor for obtaining angular rotation and speed signals of the motor rotor and an output rotation sensor for obtaining rotation and speed signals of an output end are provided at a side end of the motor rotor, where the motor rotor rotation sensor includes a motor rotor encoding ring and a motor rotor encoding PCB board, and the output rotation sensor includes an output encoding ring and an output rotation encoding PCB board; and
the motor rotor encoding ring is coaxially and fixedly connected to the first-stage sun gear or the motor rotor, the output encoding ring is coaxially and fixedly connected to the output angular rotation transfer member, and the motor rotor encoding PCB board and output rotation encoding PCB board are each fixed within the base, ensuring a hollow axis of the joint unit, so that various cables can pass through the hollow axis of the joint unit during practical applications of the robot.

As a preferred technical measure: the first-stage sun gear and the motor rotor are integrally formed, and the second-stage sun gear and the first-stage planetary carrier are integrally formed, resulting in a simple structure, high precision, and low costs.

The motor unit further includes a motor stator, and the motor rotor is an internal rotor, where an internal rotor motor results in a smaller moment of rotational inertia and a higher power density than an external rotor motor. And/or the first-stage sun gear is coaxially and rotatably connected to the first-stage planetary carrier through two bearings, making coaxiality of the sun gear and the planetary carrier good, resulting in a long life and a compact structure.

As a preferred technical measure: the base includes a sensor rear cover, an input end base, and an output end base fixedly and sealingly connected in sequence, an output end cover is fixedly provided on an outer side of the second-stage planetary carrier, and an end portion of the output angular rotation transfer member extends through the sensor rear cover; a dynamic seal assembly is provided between the output end cover and the output end base, and an oil seal assembly or a support bearing is provided between the output angular rotation transfer member and the sensor rear cover, thereby achieving good sealing protection performance for a joint.

And/or rotary centers of the output end cover and the second-stage planetary carrier are each provided with a through hole for accommodating the output angular rotation transfer member, so as to form a connection channel passing through the sensor rear cover and the output end cover. The connection channel passing through the entire rotary power unit is provided to facilitate the passage of cables and reduce external routing. Moreover, due to the use of a two-stage speed reduction system, a central sun gear can be made correspondingly larger with the same outer diameter compared with a one-stage speed reduction system, creating conditions for a central cavity. In addition, the whole rotary power unit has a hollow axis, which can facilitate the passage of various cables.

In order to achieve one of the above objectives, the fourth technical solution of the present application is as follows:
a robot, including the rotary power unit or the two-stage speed reduction rotary power unit described above, where the robot is a quadruped robot, a biped robot, or a wheel-legged robot.

In the present invention, after continuous exploration and experimentation, the output angular rotation transfer member is provided to gather up state monitoring for the input end and state monitoring for the output end, so that the states of the input end and the output end of the rotary power unit can be monitored and fed back by arranging cables at only one end of the rotary power unit, making cabling of an electrically controlled system of the rotary power unit simple, resulting in high reliability and low costs.

Further, the robot provided by the present invention may use the two-stage speed reduction rotary power unit, the speed reducer unit of which uses two-stage planetary speed reduction to provide a high speed reduction ratio; and an output speed reduction ratio may be flexibly adjusted according to different use conditions, for example, the use at a hip joint or a knee joint of a robot.

Compared with the prior art, the advantageous effects of the present invention are as follows:

In the present invention, after continuous exploration and experimentation, the output angular rotation transfer member is provided to gather up state monitoring for the input end and state monitoring for the output end, so that the output rotation sensor, together with the input rotation sensor, can be provided at a front end portion or rear end portion of the rotary power unit, in which case the states of the input end and the output end of the rotary power unit can be monitored and fed back by arranging cables at only one end of the rotary power unit, making cabling of an electrically controlled system of the rotary power unit simple, resulting in high reliability and low costs.

Further, in the present invention, after continuous exploration and experimentation, the output angular rotation transfer member is provided to gather up state monitoring for the second-stage planetary carrier and state monitoring for the motor rotor, in which case the states of the input and the output of the two-stage speed reduction rotary power unit can be monitored and fed back by arranging cables at the motor rotor, making cabling of an electrically controlled system of the rotary power unit simple, resulting in high reliability and low costs.

Still further, the speed reducer unit of the two-stage speed reduction rotary power unit provided by the present invention uses two-stage planetary speed reduction to provide a high speed reduction ratio; and an output speed reduction ratio may be flexibly adjusted according to different use conditions, for example, the use at a hip joint or a knee joint of a robot.

Furthermore, the robot provided by the present invention may use the two-stage speed reduction rotary power unit, the speed reducer unit of which uses two-stage planetary speed reduction to provide a high speed reduction ratio; and an output speed reduction ratio may be flexibly adjusted according to different use conditions, for example, the use at a hip joint or a knee joint of a robot.

The present invention is further described in detail below with reference to the drawings and specific embodiments.

### BRIEF DESCRIPTION OF THE DRAWINGS

FIG. 1 is a schematic diagram of an overall structure of a two-stage speed reduction rotary power unit according to the present invention;

FIG. 2 is an exploded view of the two-stage speed reduction rotary power unit according to the present invention;

FIG. 3 is a side view of the two-stage speed reduction rotary power unit according to the present invention; and

FIG. 4 is a sectional view of the two-stage speed reduction rotary power unit along line A-A according to the present invention.

In which: 1: base; 11: sensor rear cover; 12: input end base; 13: output end base; 2: first-stage planetary speed reduction mechanism; 21: first-stage sun gear; 22: first-stage planetary gear; 23: first-stage planetary carrier; 24: first-stage internal gear ring; 3: second-stage planetary speed reduction mechanism; 31: second-stage sun gear; 32: second-stage planetary gear; 33: second-stage planetary carrier; 34: second-stage internal gear ring; 41: motor rotor; 42: motor stator; 5: output angular rotation transfer member; 6: motor rotor rotation sensor; 61: motor rotor encoding ring; 62: motor rotor encoding PCB board; 7: output rotation sensor; 71: output encoding ring; 72: output rotation encoding PCB board; 8: accommodation cavity; 9: support seat; 91: buffer protrusion; 92: buffer recess; 10: dynamic seal assembly; 101: oil seal assembly; 102: connection channel; 103: output end cover.

### DETAILED DESCRIPTION OF THE EMBODIMENTS

In order to make the purpose, technical solutions, and advantages of the present invention clearer, the present invention will be further described below with reference to the drawings and embodiments. It should be understood that the specific embodiments described herein are only used to explain the present invention, but are not intended to limit the present invention.

On the contrary, the present invention covers any alternatives, modifications, equivalent methods and solutions defined by the claims within the spirit and scope of the present invention. Further, in order to enable the public to have a better understanding of the present invention, some specific details are described in detail in the following detailed description of the present invention. Those skilled in the art can fully understand the present invention without the description of these details.

It should be noted that when two elements are “fixed and connected”, “fixedly connected”, or “rotatably connected” to each other, the two elements may be directly connected to each other or there may be an intervening element. On the contrary, when an element is referred to as being “directly on” another element, there is no intervening element. The terms “front”, “rear”, “upper”, and “lower”, and similar expressions used herein are only for the purpose of illustration.

Unless otherwise defined, all technical and scientific terms used herein have the same meanings as those commonly understood by those skilled in the technical field of the present invention. The terms used herein are only for the purpose of describing specific embodiments and are not intended to limit the present invention. The term “and/or” used herein includes any and all combinations of one or more related listed items.

The first specific embodiment of a rotary power unit according to the present invention is as follows:
a rotary power unit,
including an input end and an output end, where
one of the input end and the output end is provided with a motor rotor rotation sensor (input rotation sensor), and the other is fixedly connected to an output angular rotation transfer member;
the output angular rotation transfer member extends toward the motor rotor rotation sensor (input rotation sensor);
an output rotation sensor is provided adjacent to the motor rotor rotation sensor (input rotation sensor); and
the output rotation sensor is connected to the output angular rotation transfer member, so as to detect states of the input end and the output end at an end of the rotary power unit.

The output angular rotation transfer member is an annular structure, a rod-shaped structure, a cage-shaped structure, a T-shaped structure, or an arc-shaped structure.

In the present invention, after continuous exploration and experimentation, the output angular rotation transfer member is provided to gather up state monitoring for the input end and state monitoring for the output end, so that the output rotation sensor, together with the motor rotor rotation sensor (input rotation sensor), can be provided at a front end portion or rear end portion of the rotary power unit, in which case the states of the input end and the output end of the rotary power unit can be monitored and fed back by arranging cables at only one end of the rotary power unit, making cabling of an electrically controlled system of the rotary power unit simple, resulting in high reliability and low costs.

The motor rotor rotation sensor, the input rotation sensor, and the output rotation sensor are photoelectric sensors, Hall rotation speed sensors, encoders, or laser rotation speed sensors, respectively.

The second specific embodiment of a rotary power unit according to the present invention is as follows:
a rotary power unit, including a motor unit and a speed reducer unit, where
the motor unit is provided with a rotation portion;
the speed reducer unit is provided with an input end and an output end;
the input end is fixedly connected to the rotation portion, and one of the input end and the output end is provided with a motor rotor rotation sensor (input rotation sensor);
the output end is fixedly connected to an output angular rotation transfer member;
the output angular rotation transfer member extends from the output end toward the motor rotor rotation sensor;
an output rotation sensor is provided adjacent to the motor rotor rotation sensor (input rotation sensor); and
the output rotation sensor is connected to the output angular rotation transfer member, so as to detect states of the input end and the output end at the input end.

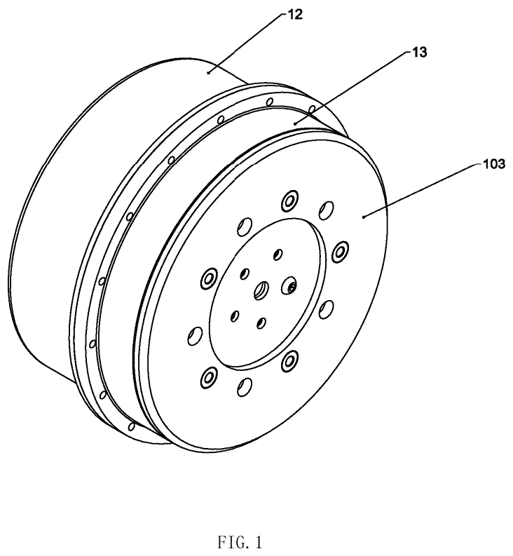

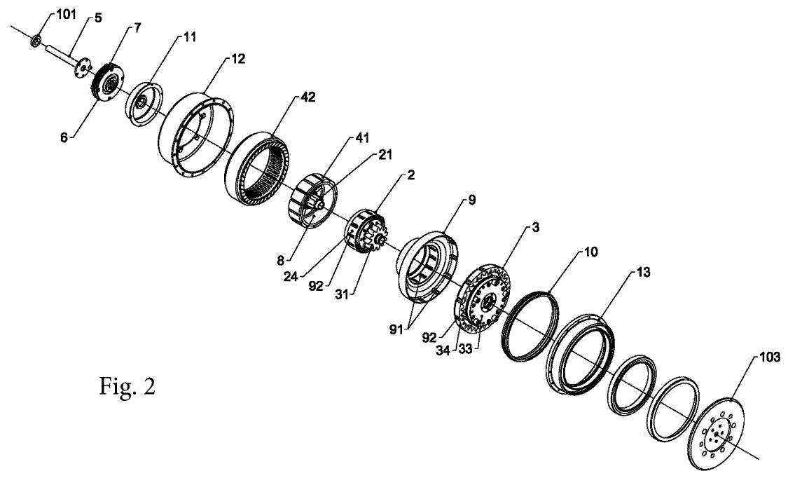

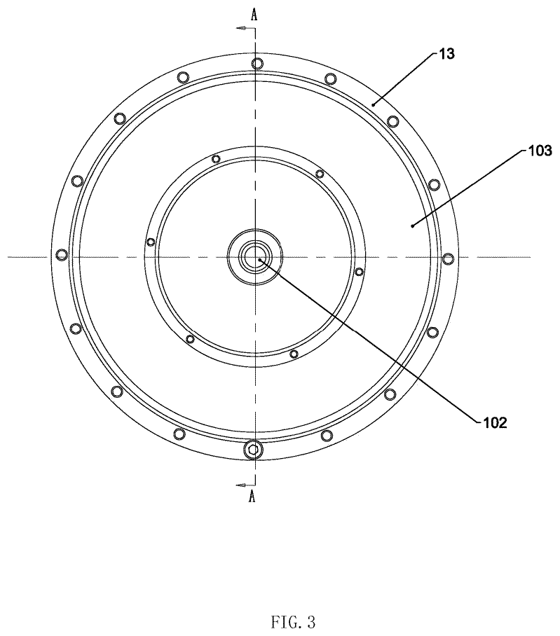

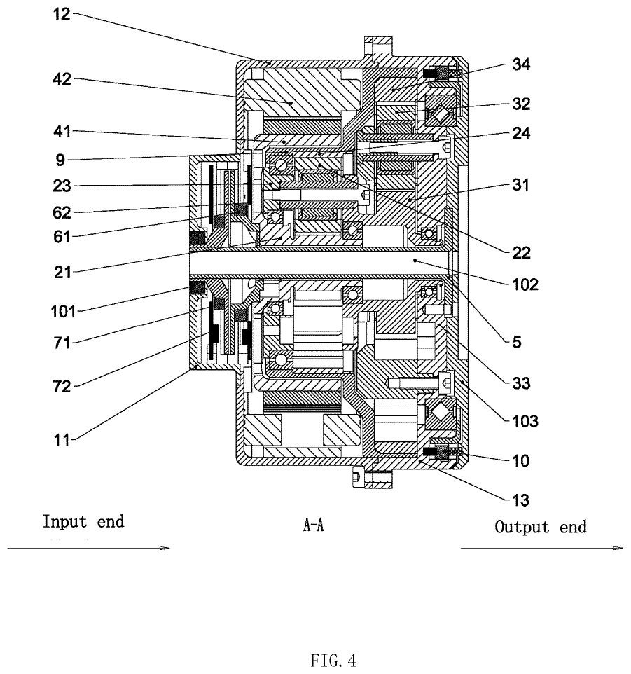

As shown in FIGS. 1, 2, 3, and 4, a specific embodiment of a two-stage speed reduction rotary power unit according to the present invention is as follows:
a two-stage speed reduction rotary power unit, including a base 1, and a motor unit and a speed reducer unit provided in the base 1, where the motor unit includes a motor rotor 41, and the speed reducer unit includes a first-stage planetary speed reduction mechanism 2 and a second-stage planetary speed reduction mechanism 3; the first-stage planetary speed reduction mechanism 2 includes a first-stage sun gear 21, a first-stage planetary gear 22, a first-stage planetary carrier 23, and a first-stage internal gear ring 24, where the first-stage sun gear 21 is coaxially and fixedly connected to the motor rotor 41, the first-stage internal gear ring 24 is fixed within the base 1, the first-stage planetary gear 22 is engaged between the first-stage sun gear 21 and the first-stage internal gear ring 24, and power is output through the first-stage planetary carrier 23; the second-stage planetary speed reduction mechanism 3 includes a second-stage sun gear 31, a second-stage planetary gear 32, a second-stage planetary carrier 33, and a second-stage internal gear ring 34, where the second-stage sun gear 31 is coaxially and fixedly connected to the first-stage planetary carrier 23, the second-stage internal gear ring 34 is fixed within the base 1, the second-stage planetary gear 32 is engaged between the second-stage sun gear 31 and the second-stage internal gear ring 34, and power is output through the second-stage planetary carrier 33.

A specific embodiment of additionally providing an output angular rotation transfer member 5 according to the present application is as follows:
a hollow output angular rotation transfer member 5 is coaxially and fixedly connected to the second-stage planetary carrier 33, and the output angular rotation transfer member 5 passes through the second-stage planetary carrier 33, the second-stage sun gear 31, the first-stage planetary carrier 23, the first-stage sun gear 21, and the motor rotor 41. The output angular rotation transfer member 5 is provided to synchronize and transfer rotary information of an output end of the rotary power unit to an input end, so as to integrate the motor rotor rotation sensor 6 and the output rotation sensor 7 at the input end, avoiding the external arrangement of control cables inside the rotary power unit.

A specific embodiment of additionally providing a sensor according to the present invention is as follows:
a motor rotor rotation sensor 6 for obtaining angular rotation and speed signals of the input end and an output rotation sensor 7 for obtaining angular rotation and speed signals of the output end are provided at a side end of the motor rotor 41, where the motor rotor rotation sensor 6 includes a motor rotor encoding ring 61 and a motor rotor encoding PCB board 62, and the output rotation sensor 7 includes an output encoding ring 71 and an output rotation encoding PCB board 72; and the motor rotor encoding ring 61 is coaxially and fixedly connected to the first-stage sun gear 21 or the motor rotor 41, the output encoding ring 71 is coaxially and fixedly connected to the output angular rotation transfer member 5, and the motor rotor encoding PCB board 62 and output rotation encoding PCB board 72 are each fixed within the base 1. The motor rotor rotation sensor 6 and the output rotation sensor 7 are provided to facilitate direct measurement of an angle of the output end of the rotary power unit, and the output rotation sensor 7 is provided on the same side as the motor rotor rotation sensor 6, resulting in a simple and convenient structure and low costs.

A specific embodiment of a structure of the input end according to the present invention is as follows:
the first-stage sun gear 21 and the motor rotor 41 are integrally formed, and the second-stage sun gear 31 and the first-stage planetary carrier 23 are integrally formed; the motor unit further includes a motor stator 42, and the motor rotor 41 is an internal rotor; and the motor rotor 41 is recessed inward at a rotary center to form an accommodation cavity 8 for accommodating the first-stage planetary speed reduction mechanism 2. An internal rotor motor results in a smaller moment of rotational inertia and a higher power density than an external rotor motor. The rotor is provided with the accommodation cavity 8 therein for accommodating the first-stage planetary speed reduction mechanism 2, so as to make full use of the space, thus making the rotary power unit have a more compact overall structure and a smaller volume.

A specific embodiment of a support structure according to the present invention is as follows:
a support seat 9 is directly fixed within the base 1, and the first-stage internal gear ring 24 and the second-stage internal gear ring 34 are each fixed within the base 1 through the support seat 9; and a buffer protrusion 91 and a buffer recess 92 matching each other are provided between the first-stage internal gear ring 24 and the support seat 9 and between the second-stage internal gear ring 34 and the support seat 9, respectively. The buffer protrusion 91 and the buffer recess 92 matching each other are provided between the first-stage internal gear ring 24 and the support seat 9 and between the second-stage internal gear ring 34 and the support seat 9, respectively. During use, when an external impact force is transferred into the rotary power unit, the first-stage internal gear ring 24 and the second-stage internal gear ring 34 each can rotate relative to the support seat 9, so as to absorb a part of impact energy, thereby preventing structural damage to components and parts of the rotary power unit due to the external impact.

A specific embodiment of providing a seal structure according to the present invention is as follows:
The base 1 includes a sensor rear cover 11, an input end base 12, and an output end base 13 fixedly and sealingly connected in sequence, an output end cover 103 is fixedly provided on an outer side of the second-stage planetary carrier 33, and an end portion of the output angular rotation transfer member 5 extends through the sensor rear cover 11; a dynamic seal assembly 10 is provided between the output end cover 103 and the output end base 131, and an oil seal assembly 101 is provided between the output angular rotation transfer member 5 and the sensor rear cover 11. The dynamic seal assembly 10 and the oil seal assembly 101 are provided at the connection to make the rotary power unit have good waterproofness. Moreover, a structurally compact mechanical seal ring is provided on an output end side of the rotary power unit to prevent dust, water, etc. from entering the rotary power unit.

A specific embodiment of hollow routing according to the present invention is as follows:
rotary centers of the output end cover 103 and the second-stage planetary carrier 33 are each provided with a through hole in communication with the output angular rotation transfer member 5, so as to form a connection channel 102 passing through the sensor rear cover 11 and the output end cover 103. The connection channel 102 passing through the entire rotary power unit is provided to facilitate the passage of cables and reduce external routing. Moreover, due to the use of a two-stage speed reduction system, a central sun gear can be made correspondingly larger with the same outer diameter compared with a one-stage speed reduction system, creating conditions for a central cavity. In addition, the whole rotary power unit has a hollow axis, which can facilitate the passage of various cables.

A specific embodiment of a robot according to the present invention is as follows:
a robot, including the two-stage speed reduction rotary power unit described above.

In the present application, the fixed connection or fixation-connection manner may be screwed connection, welding connection, riveting connection, insertion connection, or connection by a third component, and those skilled in the art can make a choice according to an actual situation.

Finally, it should be noted that the above embodiments are only used to illustrate the technical solution of the present invention, and are not intended to limit them. Although the present invention is described in detail with reference to the above embodiments, those skilled in the art should understand that they may still make modifications or equivalent replacements to the specific embodiments of the present invention, and any modifications or equivalent replacements that do not deviate from the spirit and scope of the present invention shall be covered by the protection scope of claims of the present invention.

1. A rotary power unit,
comprising an input end and an output end, wherein
one of the input end and the output end is provided with an input rotation sensor, and the other is fixedly connected to an output angular rotation transfer member;
the output angular rotation transfer member extends toward the input rotation sensor;
an output rotation sensor is provided at a position adjacent to the input rotation sensor; and
the output rotation sensor is connected to the output angular rotation transfer member, so as to detect states of the input end and the output end at an end of the rotary power unit.

2. The rotary power unit according to claim 1, wherein
the input end and the output end are each provided with a hollow rotary center; and
the output angular rotation transfer member is a T-shaped structure provided with a through hole, and a rod portion thereof passes through the hollow rotary center.

3. A rotary power unit, comprising a motor unit and a speed reducer unit, wherein
the motor unit is provided with a rotation portion;
the speed reducer unit is provided with an input end and an output end;
the input end is fixedly connected to the rotation portion, and one of the input end and the output end is provided with an input rotation sensor;
the output end is fixedly connected to an output angular rotation transfer member;
the output angular rotation transfer member extends from the output end toward the input rotation sensor;
an output rotation sensor is provided at a position adjacent to the input rotation sensor; and
the output rotation sensor is connected to the output angular rotation transfer member, so as to detect states of the input end and the output end at the input end.

4. A two-stage speed reduction rotary power unit, comprising a base, and a motor unit and a speed reducer unit provided in the base wherein
the motor unit comprises a motor rotor, and the speed reducer unit comprises a first-stage planetary speed reduction mechanism and a second-stage planetary speed reduction mechanism;
the first-stage planetary speed reduction mechanism comprises a first-stage sun gear a first-stage planetary gear, a first-stage planetary carrier, and a first-stage internal gear ring, wherein the first-stage sun gear is coaxially and fixedly connected to the motor rotor, the first-stage internal gear ring is fixed within the base the first-stage planetary gear is engaged between the first-stage sun gear and the first-stage internal gear ring and power is output through the first-stage planetary carrier);
the second-stage planetary speed reduction mechanism comprises a second-stage sun gear, a second-stage planetary gear, a second-stage planetary carrier, and a second-stage internal gear ring, wherein the second-stage sun gear is coaxially and fixedly connected to the first-stage planetary carrier, the second-stage internal gear ring is fixed within the base the second-stage planetary gear is engaged between the second-stage sun gear and the second-stage internal gear ring, and power is output through the second-stage planetary carrier and
a hollow output angular rotation transfer member is coaxially and fixedly connected to the second-stage planetary carrier and the output angular rotation transfer member extends toward the motor rotor.

5. The two-stage speed reduction rotary power unit according to claim 4, wherein
the motor rotor is recessed inward at a rotary center to form an accommodation cavity for accommodating the first-stage planetary speed reduction mechanism;
and/or the output angular rotation transfer member passes through the second-stage planetary carrier, the second-stage sun gear, the first-stage planetary carrier the first-stage sun gear, and the motor rotor; and
the output angular rotation transfer member is an annular structure, a rod-shaped structure, a cage-shaped structure, a T-shaped structure, or an arc-shaped structure.

6. The two-stage speed reduction rotary power unit according to claim 5, wherein a support seat is directly fixed within the base and the first-stage internal gear ring and the second-stage internal gear ring are each fixed within the base through the support seat; and
a buffer protrusion and a buffer recess matching each other are provided between the first-stage internal gear ring and the support seat and between the second-stage internal gear ring and the support seat, respectively.

7. The two-stage speed reduction rotary power unit according to claim 4, wherein
a motor rotor rotation sensor for obtaining angular rotation and speed signals of the motor rotor and an output rotation sensor for obtaining rotation and speed signals of an output end are provided at a side end of the motor rotor wherein the motor rotor rotation sensor comprises a motor rotor encoding ring and a motor rotor encoding PCB board and the output rotation sensor comprises an output encoding ring and an output rotation encoding PCB board; and
the motor rotor encoding ring is coaxially and fixedly connected to the first-stage sun gear or the motor rotor, the output encoding ring is coaxially and fixedly connected to the output angular rotation transfer member and the motor rotor encoding PCB board and output rotation encoding PCB board are each fixed within the base

8. The two-stage speed reduction rotary power unit according to claim 4, wherein the first-stage sun gear and the motor rotor are integrally formed, and the second-stage sun gear and the first-stage planetary carrier are integrally formed;
the motor unit further comprises a motor stator, and the motor rotor is an internal rotor; and/or
the first-stage sun gear is coaxially and rotatably connected to the first-stage planetary carrier through two bearings.

9. The two-stage speed reduction rotary power unit according to claim 8, wherein the base comprises a sensor rear cover, an input end base, and an output end base fixedly and sealingly connected in sequence, an output end cover is fixedly provided on an outer side of the second-stage planetary carrier and an end portion of the output angular rotation transfer member extends through the sensor rear cover; a dynamic seal assembly is provided between the output end cover and the output end base and an oil seal assembly or a support bearing is provided between the output angular rotation transfer member and the sensor rear cover; and/or
rotary centers of the output end cover and the second-stage planetary carrier are each provided with a through hole for accommodating the output angular rotation transfer member so as to form a connection channel passing through the sensor rear cover and the output end cover.

10. A robot, comprising the rotary power unit according to claim 1, wherein the robot is a quadruped robot, a biped robot, or a wheel-legged robot.

11. A robot, comprising the two-stage speed reduction rotary power unit according to claim 4, wherein the robot is a quadruped robot, a biped robot, or a wheel-legged robot.
